(19) United States
(12) Patent Application Publication
(10) Pub. No.: US 2022/0345219 A1
(43) Pub. Date: Oct. 27, 2022

(54) Wireless Optical Networking Unit

(71) Applicant: CORTINA ACCESS, INC., San Jose, CA (US)

(72) Inventor: Florin Daniel Apetrei, Fremont, CA (US)

(21) Appl. No.: 17/238,366

(22) Filed: Apr. 23, 2021

(51) Int. Cl. H04B 10/11; H04B 10/27

(52) U.S. Cl. CPC H04B 10/11; H04B 10/27

(57) ABSTRACT

A Wireless Optical Network Terminal (WONT) includes an interior connection module having an interior communication module having a transceiver configured with technology to enable data to be transferred wirelessly through building materials, a resonance power transmitter, and a connector configured to connect the interior communication module and the resonance power transmitter to a power supply. The WONT further includes an exterior connection module having an exterior communication module having a transceiver configured with a same technology to enable data to be transferred wirelessly through building materials as is present in the interior communication module, a resonance power receiver configured to provide power to the exterior communication module, and a connector configured to permit the exterior connection module to be an optical network terminal (ONT) of a passive optical network (PON).

### BACKGROUND OF THE INVENTION

### 1. Field of the Invention

This application relates to installation of a fiber optic network service to an existing building, and more particularly to a wireless optical networking unit for installation of a fiber optic network service to an existing building without requiring any physical connection through the building's exterior wall, foundation, or roof.

### 2. Description of the Prior Art

Installation of a fiber optic network service to an existing building can be expensive and time consuming. The installation often requires an exterior power source. Holes may need to be drilled through the building wall, which involves scheduling coordination between the installer and customer to arrange a suitable time in which the customer is home. For service providers that that typically deploys separate truck rolls for optic network terminal and router installation a second truck roll may also be required. Additionally, after having been installed, upgrade and/or repair of the fiber optic network service can be costly and difficult.

### SUMMARY OF THE INVENTION

A Wireless Optical Network Terminal (WONT) is proposed. The WONT comprising an interior connection module comprising an interior communication module having a transceiver configured with technology to enable data to be transferred wirelessly through building materials, a resonance power transmitter, and a connector configured to connect the interior communication module and the resonance power transmitter to a power supply. The WONT further comprises an exterior connection module comprising an exterior communication module having a transceiver configured with a same technology to enable data to be transferred wirelessly through building materials as is present in the interior communication module, a resonance power receiver configured to provide power to the exterior communication module, and a connector configured to permit the exterior connection module to be an optical network terminal (ONT) of a passive optical network (PON).

The Wireless Optical Network Terminal (WONT) may further comprise a Passive Optical Network (PON) Media Access Control (MAC) unit. A first antenna coupled to the interior communication module and a second antenna coupled to the exterior communication module are each configured for transmitting and receiving a modulated radio frequency RF signal.

The exterior connection module of the WONT may comprise first and second sub-modules, the first sub-module comprising the transceiver and the resonance power receiver configured to provide power to the transceiver, the second sub-module comprising the optical network terminal (ONT) of the passive optical network (PON), the first and second sub-modules electrically coupled by a power over Ethernet (PoE)cable.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram example of a basic WONT according to some embodiments.

FIG. 2 illustrates more detail about an embodiment having an interior connection module and an exterior connection as shown in FIG. 1.

FIG. 3 illustrates an additional embodiment where the external connection module is separated into two sub-modules connected via a single power over Ethernet (PoE) cable.

FIG. 4 illustrates an additional embodiment where the internal connection module connects to the indoor router via a power over Ethernet connection.

FIG. 5 illustrates an additional embodiment where the internal connection module is modified to be fully integrated with a conventional Wi-Fi™ router.

### DETAILED DESCRIPTION

This application is directed toward a Wireless Optical Network Terminal (WONT) which connects a building to fiber optic network service without requiring any physical connection through the building's exterior wall, foundation, or roof.

The proposed WONT uniquely combines a conventional optical network terminal with AirPHY™, Wi-Fi, or any other modulated radio frequency (RF) signal that does not go above mandated Federal Communication Commission (FCC) noise levels, hereinafter referred to as transceivers (for ease of explanation), for data and a magnetic resonance power transmission system. The transceivers provide an Ethernet bridge through the building exterior wall while the power system wirelessly transmits power from the interior surface to the exterior surface without requiring any openings through the building wall.

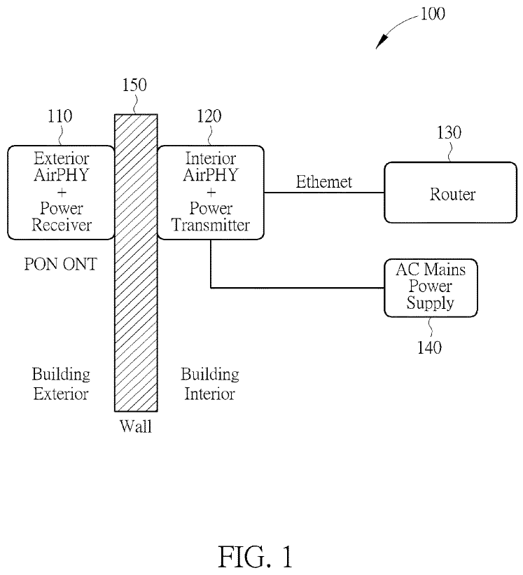

FIG. 1 provides a block diagram example of a basic WONT according to some embodiments. As example 100 shows, the proposed wireless optical networking unit may comprise an interior connection module 120 and an exterior connection module 110. The exterior connection module 110 may be affixed to, or adjacent to, a surface of an exterior wall 150 of the building. The internal connection module 120 may be affixed to, or adjacent to, an interior surface of the outer building wall 150 and aligned with the exterior connection module 110.

The exterior connection module 110 may be connected to and functions as an optical network terminal (ONT) of a passive optical network (PON), which may be connected to the service provider's central office. The exterior connection module 110 may comprise an exterior communication module having technology that enables data to be transferred wirelessly through typical building materials. The exterior communication module may be, for example, an AirPHY™ module, a Wi-Fi module, or any other type of transceiver capable of transmitting and receiving a modulated radio frequency (RF) signal. To provide power, the exterior connection module 110 may also comprise a resonance power receiver compatible with a wireless power receiving technology such as Qi created by the Wireless Power Consortium (WPC), PMA (Power Matters Alliance), or Airfuel™ (Airfuel Alliance), but not limited to these standards.

The internal connection module 120 may comprise an interior communication module having the same technology embodied in the exterior communication module. The interior connection module 120 may also comprise a resonance power transmitter compatible with the same wireless power receiving technology that the power receiver of the exterior module 110 utilizes. Power can be provided to the internal connection module 120 through a connection to an AC mains power supply 140. The internal connection module 120 may further comprise an Ethernet or other (e.g. MoCA or G.hn) network connection to a router 130.

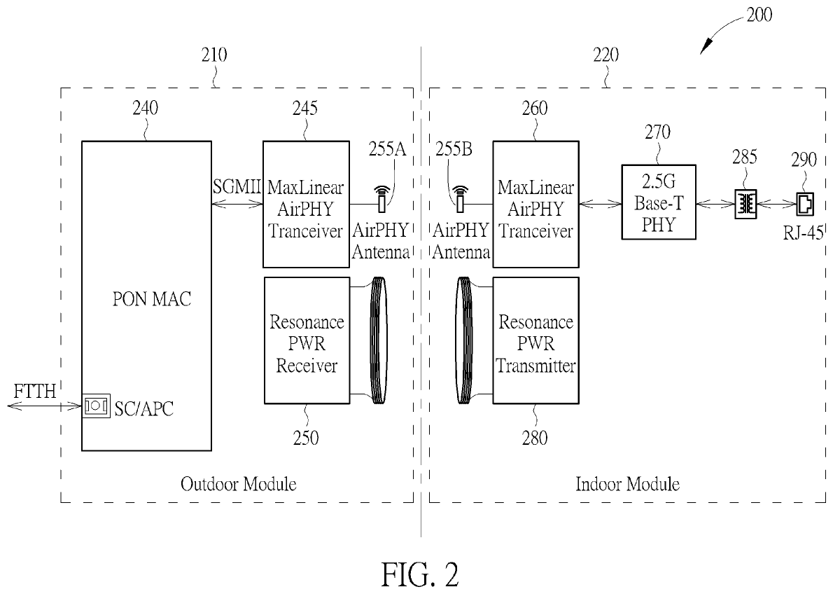

FIG. 2 illustrates more detail about an embodiment 200 having an interior connection module 220 and an exterior connection module 210 that may be respectively similar to the interior connection module 120 and the exterior connection module 110. The exterior connection module 210 may comprise a fiber-optic telecommunications technology for delivering broadband network access to end-customers such as a Passive Optical Network (PON) Media Access Control (MAC) 240. The PON MAC 240 may comprise a connection port, such as a Standard Connector/Angled Physical Contact (SC/APC) connector 260, which may be connected to the fiber-optic network via, for example, a fiber-to-the-home (FTTH) technology.

The PON MAC 240 may be connected to the exterior communication module 245 via a connection bus for Ethernet Media Access Controllers (MACs) and Physical Layer Devices (PHYs). The connection bus may be a Serial Gigabit Media Independent Interface (SGMII), but not limited thereto. Here, and throughout this application any specifics The exterior communication module 245 may comprise an AirPHY™ module, a Wi-Fi module, or any other type of transceiver capable of transmitting and receiving a modulated radio frequency (RF) signal. A compatible antenna 255A is attached to the exterior communication module 245 for transmitting and receiving the modulated RF signal.

The exterior connection module 210 may further comprise a resonance power receiver 250 connected to provide electrical power to components of the exterior connection module 210. Because any power requirements of the exterior connection module 210 can be supplied by the resonance power receiver 250, there is no need for another power source to provide electricity to the exterior connection module 210, simplifying installation.

The interior connection module 220 may comprise a resonance power transmitter 280 compatible with the resonance power receiver 250 to provide electrical power to components of the exterior connection module 210. The resonance power transmitter 280 may be connected to obtain power from an AC mains power supply 140 as illustrated in FIG. 1.

The interior connection module 220 may also comprise an interior communication module 260 comprising a transceiver capable of transmitting and receiving a modulated radio frequency RF signal, the transceiver preferably compatible with the technologies used by the exterior communication module 245. The interior communication module 260 may be coupled to an antenna 255B.

The interior communication module 260 may be serially coupled to an RJ-45 connector comprised by the interior connection module 220 via an Ethernet connection that may include a 2.5GBASE-T PHY layer 270 and a transformer 285, although the connection is not limited to this. In some embodiments, the RJ-45 connector may be connected to a router 130 as shown in FIG. 1.

In short, for installation of the wireless optical networking unit, the exterior connection module 210 is affixed to or adjacently placed near an external surface of a building's outer wall and connected to the optical network of the service provider's central office. The interior connection module 220 is affixed to or adjacently placed at a corresponding position on the internal surface of the same building's outer wall and plugged into an AC mains power source. The interior connection module 220 provides resonance power to the exterior connection module 210 and the interior communication module 260 and the exterior connection module 245 wirelessly provide an Ethernet connection from the service provider to the interior connection module 220 inside of the building. No outdoor power source is required and a prior art need to drill holes through the building wall is eliminated.

It should be stated that some of the specific technologies mentioned throughout this application are intended to only be examples that could be utilized to demonstrate fashioning embodiments of the invention and are not limited to these specific technologies. For example, the embodiments 100, 200, 300, 400, and 500 and others could be implemented using any PON technology if the PON MAC supports them. Additionally and related to the Ethernet side on both the internal and external module, the embodiments are not limited to 2.5G as shown in FIG. 2. The embodiments 100, 200, 300, 400, and 500 and others could be implemented using technology based on IEEE 802.3bz specifications, such as NBASE-T, MGBASE-T, 2.5GBASE-T, and 5GBASE-T, assuming the ETH MAC supports it.

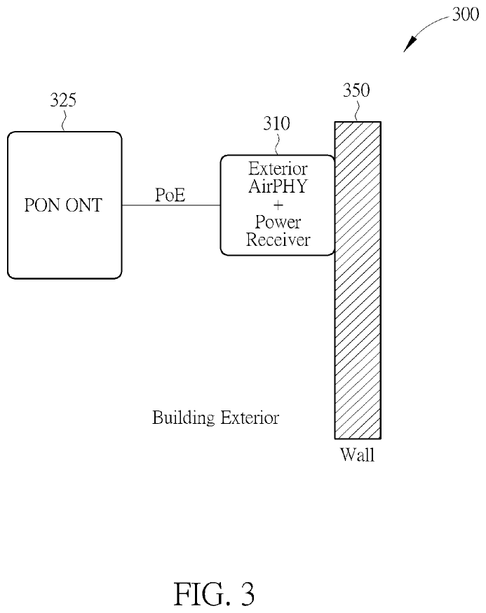

FIG. 3 illustrates an additional embodiment 300 where the external connection module of the wireless optical networking unit is modified to provide additional location flexibility and modular reparability. In the embodiment 300, at least a portion of the external connection module is still fixed to or adjacent to an outer surface of a building's outer wall 350. The embodiment 300 still includes the exterior transceiver and associated antenna, a network terminal PON ONT, and the power receiver as in the previous embodiments. A difference here is that the external connection module can be separated into two sub-modules 310, 325 that separate the network terminal PON ONT subsystem 325 from the transceiver and power receiver 310 via a single power over Ethernet (PoE) cable.

The external connection module of the embodiment 300 can be pared with the interior connection module 220 or with the interior connection module of another embodiment described later to wirelessly provide an Ethernet connection from the service provider to the interior connection module inside of the building. No outdoor power source is required and a prior art need to drill holes through the building wall is eliminated. In variations of the embodiment 300, converting the customer from an optical network service to another type of service can be supported by replacing the ONT with other types of wired terminal equipment such as a DOCSIS or DSL transceiver.

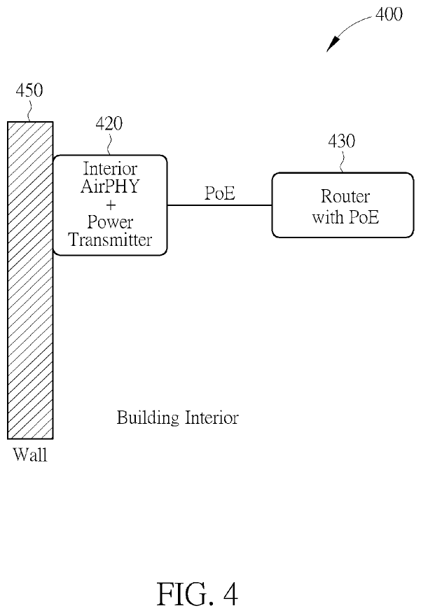

FIG. 4 illustrates an additional embodiment 400 where the internal connection module 420 of the wireless optical networking unit is modified to connect to the indoor router 430 via power over Ethernet connection, thus reducing the number of cables, or the interior module could be fully integrated with a conventional router Wi-Fi™ router. In the embodiment 400, at least a portion of the internal connection module 420 is still fixed to or adjacent to an inner surface of a building's outer wall 450. The embodiment 400 still includes the interior transceiver with associated antenna and power transmitter as in the previous embodiments. A difference here is no additional connection to the AC mains power supply 140 is needed. This can provide additional installation and locational flexibility compared to previous embodiments of the internal connection module.

The internal connection module of the embodiment 400 can be pared with the exterior connection module 120 or with the exterior connection module of another embodiment to provide wirelessly an Ethernet connection from the service provider to inside of the building. No outdoor power source is required and the prior art need to drill holes through the building wall for the Ethernet connection is eliminated.

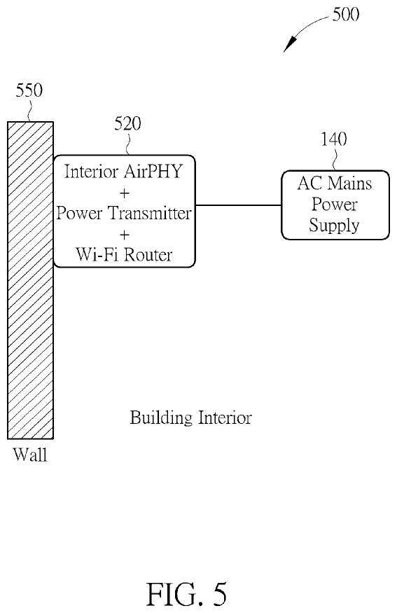

FIG. 5 illustrates an additional embodiment 500 where the internal connection module 520 of the wireless optical networking unit is modified to be fully integrated with a conventional Wi-Fi™ router, again reducing the number of cables. In the embodiment 500, the internal connection module 520 is still fixed to or adjacent to an inner surface of a building's outer wall 550. The embodiment 500 still includes the interior transceiver with associated antenna and power transmitter as in the previous embodiments of an internal connection module, in addition to the fully integrated Wi-Fi-router and further includes a connection to the AC mains power supply 140. This can provide additional installation and locational flexibility and compactness compared to other embodiments of the internal connection module due to the integrated router.

The internal connection module of the embodiment 500 can be pared with the exterior connection module 120 or with the exterior connection module of the other embodiments to provide wirelessly an Ethernet connection from the service provider to inside of the building. No outdoor power source is required and the prior art need to drill holes through the building wall for the Ethernet connection is eliminated.

Embodiments of the proposed wireless optical networking unit can solve prior art problems including reduced cost of installation of the fiber optic network service. Professional installation time is reduced because installation can be limited to just an exterior component that can be conveniently placed virtually anywhere on the exterior of a building, requires no outdoor power source, eliminates a requirement to drill holes through the building wall, and increases scheduling flexibility because the technician does not need to enter the building. For service providers that typically deploy separate truck rolls for ONT and router installation, the interior component can be self-installed by the end customer eliminating the second truck roll. Additionally, the modular design simplifies upgrade and repair.

Those skilled in the art will readily observe that numerous modifications and alterations of the de-vice and method may be made while retaining the teachings of the invention. Accordingly, the above disclosure should be construed as limited only by the metes and bounds of the appended claims.

1. A Wireless Optical Network Terminal (WONT) comprising:
an interior connection module comprising:
an interior communication module having a transceiver configured with technology to enable data to be transferred wirelessly through building materials;
a resonance power transmitter; and
a connector configured to connect the interior communication module and the resonance power transmitter to a power supply; and
an exterior connection module comprising:
an exterior communication module having a transceiver configured with a same technology to enable data to be transferred wirelessly through building materials as is present in the interior communication module;
a resonance power receiver configured to provide power to the exterior communication module; and
a connector configured to permit the exterior connection module to be an optical network terminal (ONT) of a passive optical network (PON);
wherein the exterior connection module comprises first and second sub-modules, the first sub-module comprising the transceiver and the resonance power receiver configured to provide power to the transceiver, the second sub-module comprising the optical network terminal (ONT) of the passive optical network (PON), the first and second sub-modules electrically coupled by a power over Ethernet (PoE) cable.

2. The Wireless Optical Network Terminal (WONT) of claim 1, wherein the external connection module further comprises a Passive Optical Network (PON) Media Access Control (MAC) unit.

3. The Wireless Optical Network Terminal (WONT) of claim 2, wherein the Passive Optical Network (PON) Media Access Control (MAC) unit is coupled to the exterior communication module via a connection bus for Ethernet Media Access Controllers (MACs) and Physical Layer Devices (PHYs).

4. The Wireless Optical Network Terminal (WONT) of claim 1, wherein the connector of the exterior connection module comprises a Standard Connector/Angled Physical Contact (SC/APC) connector configured to connect to a fiber-optic network.

5. The Wireless Optical Network Terminal (WONT) of claim 1, further comprising an antenna coupled to the exterior communication module for transmitting and receiving a modulated RF signal.

6. The Wireless Optical Network Terminal (WONT) of claim 1, wherein the interior communication module comprises a transceiver capable of transmitting and receiving a modulated radio frequency RF signal.

7. The Wireless Optical Network Terminal (WONT) of claim 6, wherein the transceiver is coupled to an antenna for transmitting and receiving the modulated radio frequency RF signal from the exterior communication module.

8. The Wireless Optical Network Terminal (WONT) of claim 1, wherein the interior connection module further comprises an RJ-45 connector coupled to the interior communication module.

9. The Wireless Optical Network Terminal (WONT) of claim 1, wherein the interior connection module further comprises a serially connected interior communication module, a PHY layer, a transformer, and an RJ-45 connector.

10. (canceled)

11. The Wireless Optical Network Terminal (WONT) of claim 1, wherein the connector of the internal connection module is configured to connect to a power over Ethernet (PoE) cable.

12. The Wireless Optical Network Terminal (WONT) of claim 1, wherein the internal connection module further comprises an integrated router.

13. The Wireless Optical Network Terminal (WONT) of claim 1, wherein there is no physical connection between the internal connection module and the external connection module, wherein the external connection module and the internal connection module are substantially aligned.

14. A Wireless Optical Network Terminal (WONT) comprising:
an interior connection module comprising:
an interior communication module having a transceiver configured with technology to enable data to be transferred wirelessly through building materials via radio frequency transmissions;
a resonance power transmitter configured to be compatible with a wireless power receiving technology that a corresponding resonance power receiver utilizes; and
a connector configured to connect the interior communication module and the resonance power transmitter to a power supply.

15. (canceled)

16. The Wireless Optical Network Terminal (WONT) of claim 14, wherein the internal connection module further comprises an integrated router.

17. A Wireless Optical Network Terminal (WONT) comprising:
an exterior connection module comprising:
an exterior communication module having a transceiver configured with technology to enable data to be transferred wirelessly through building materials;
a resonance power receiver configured to be compatible with a wireless power receiving technology and provide power to the exterior communication module; and
a connector configured to permit the exterior connection module to be an optical network terminal (ONT) of a passive optical network (PON);
wherein the exterior connection module comprises first and second sub-modules, the first sub-module comprising the transceiver and the resonance power receiver configured to provide power to the transceiver, the second sub-module comprising the optical network terminal (ONT) of the passive optical network (PON), the first and second sub-modules electrically coupled by a power over Ethernet (PoE) cable.

18. (canceled)
